(19) United States
(12) Patent Application Publication
(10) Pub. No.: US 2016/0355002 A1
(43) Pub. Date: Dec. 8, 2016

(54) ARTICLES AND METHODS FOR APPLYING SHEETS ON SURFACES

(71) Applicant: Akomeno Oruarog Egware, Regina (CA)

(72) Inventor: Akomeno Oruarog Egware, Regina (CA)

(21) Appl. No.: 14/733,409

(22) Filed: Jun. 8, 2015

(51) Int. Cl. B32B 37/12; B32B 43/00; E04F 21/00; B32B 37/26

(52) U.S. Cl. CPC B32B 37/12; B32B 37/26; B32B 43/006; E04F 21/00; B32B 2037/1246; B32B 2037/268; B32B 2419/00; B32B 2333/00; B32B 2323/00; B32B 2375/00; B32B 2571/00

(57) ABSTRACT

The present invention provides an apparatus and methods for applying sheets on surfaces. Articles for protective coverings on a surface may comprise a sheet of polymer and an adhesive on one or more sheet surfaces. The article may further include a first releasable liner, a second releasable liner, and the sheet between the liners. Methods for providing a protective sheeting material on an architectural surface may comprise applying the sheet to the architectural surface with two sides of adhesive.

### BACKGROUND OF THE INVENTION

The present invention relates generally to articles and methods for applying laminate sheets on a surface, and particularly to applying sheets of color and texture on a surface, for example an architectural surface. One advantage of applying a sheet (such as a drop cloth) is to avoid mess caused by the use of wet tools such as brushes, rollers, sprayers. The present invention relates specifically to articles and methods for applying sheets or drapes to wall surfaces in an easy and comparatively rapid manner by removing pre-applied adhesive strips on one or more side of a sheet.

Architectural surfaces, such as interior and exterior walls or the like, may be applied with one or more colors for aesthetic benefits and/or functional benefits, such as resistance to environmental factors (e.g., wind, rain, sun, snow, dust). The present invention may also be useful to protect neighboring surfaces (such as adjacent walls or other nearby surfaces) while spraying or otherwise applying paint or other substances to architectural surfaces. In another embodiment, the present invention may even be useful to protect walls of neighboring buildings against overspray, splatter, or other debris resulting from applying substances to the intended architectural surface. The present invention permits rapid and easy application of sheet material before treating an architectural surface and rapid and easy removal of the sheet material afterwards.

Color may be applied by conventional painting with oil-based or water-based paints, wallpaper, or the like. These processes require a great deal of labor. For example, adjacent areas must be masked and protected from undesired application of paint. Drop cloths often must be arranged to protect floors, furniture, and the like to avoid paint landing on those items. Still, a significant amount of paint and other substances are used that remain on the tools and never are applied to the desired surface (such as from the need to saturate brushes and rollers with paint). A significant amount of time is spent on cleaning the brushes, rollers, sprayers, and other tools.

To avoid many of these drawbacks to applying sheets in wall applications, one scheme has been to apply laminate sheets that comprise a sheet of a polymer component, an adhesive on one surface of the sheet, and a releasable liner, wherein the sheet can be located between the releasable liner and the adhesive. The adhesive may be adapted to adhere the sheet to a surface at normal room temperature and pressure. The sheet may be known as a “drape” and applying such a sheet may be known as “draping” a sheet onto an architectural surface, such as a wall, ceiling, or floor.

Still, the customary draping process for applying the draping sheets to a surface leaves much to be desired. The application process requires precise alignment of the sheet edges with the edges of the surface to be applied to, such as a wall, ceiling, floor, and the like. Most surfaces are large enough that one person usually needs assistance from another person to hold and support the sheet while aligning the surface edges with the sheet edges. The process would be greatly improved if the sheet could be adapted to more easily be aligned and draped with ease and accuracy without needing extra personnel. Such an improvement would save labor expenses and minimize the time involved with hanging the draping sheets.

It would be advantageous to provide an apparatus, method, and process that would include one or more of the features of 1) permitting ease of applying the sheet on a surface; 2) accuracy of aligning the sheet edges with surface edges; 3) decreasing the time for applying the sheet to a surface; 4) permitting wet work on a ceiling while protecting adjacent walls, other surfaces, and other articles from splatter or other debris; 5) serving as a vapor barrier for insulation of walls; and 6) saving labor involved.

### SUMMARY OF THE INVENTION

In one aspect of the present invention, an architectural surface covering product comprises; a flexible and conformable sheet, the sheet having an inside surface and an outside surface, a repositionable pressure-sensitive adhesive situated on the inside surface of the sheet, an inside releasable liner being releasably adhered to the inside surface of the sheet, an outside releasable liner being releasably adhered to the outside surface of the sheet, wherein the inside releasable liner has an inner surface and an outer surface, wherein the inner surface of the inside releasable liner is releasably adhered to the inside surface of the sheet and a release agent is situated on the inner surface of the inside releasable liner.

In another aspect of the present invention, a self-wound multi-layer laminate sheet for applying a layer of color to a substrate surface, the laminate sheet comprises; a dry paint layer comprising a color layer including a binder and a pigment, the dry paint layer having an upper surface and a lower surface, a pressure-sensitive adhesive layer overlying the upper surface of the dry paint layer and adapted for adhering the laminate sheet to a substrate surface, a release liner overlying the lower surface of the dry paint layer, the release liner having a dry paint release coat releasably adhered to the lower surface of the dry paint layer, and an adhesive release coat layer on a side of the release liner opposite from the dry paint release coat removable from the dry paint layer, wherein the dry paint release coat transferring a controlled surface finish to an exposed surface of the dry paint layer when the pressure-sensitive adhesive layer adheres the laminate sheet to the substrate surface under the application of pressure and the release liner is peeled away from the dry paint layer, wherein the laminate sheet is adapted for being self-wound into a roll with the pressure-sensitive adhesive layer in contact with the adhesive release coat layer, wherein the adhesive release coat layer and the pressure-sensitive adhesive layer have an unwind release force between them which is lower than a carrier release force between the dry paint release coat and the dry paint layer, such that the adhesive release coat preferentially releases the liner from contact with the pressure-sensitive adhesive layer when unwinding the laminate sheet from its roll form, while the dry paint release coat maintains contact with the dry paint layer when the laminate is being unwound from its roll form, wherein the pressure-sensitive adhesive is selected from the group consisting of a cross-linked acrylic resinous material, an internally cross-linked acrylic emulsion, and a cross-linked co-polymer emulsion of butyl acrylate and ethyl hexyl acrylate.

In yet another aspect of the present invention, a method of applying a sheet on an architectural substrate comprises; contacting a portion of a substrate with a composition comprising; a flexible and conformable sheet, the sheet having an inside surface and an outside surface, a repositionable pressure-sensitive adhesive situated on the inside surface of the sheet, an inside releasable liner being releasably adhered to the inside surface of the sheet, an outside releasable liner being releasably adhered to the outside surface of the sheet, removing the inside releasable liner from the inside surface of the sheet, applying pressure to the sheet to cause the sheet to adhere to the substrate; and removing the outside releasable liner from the outside surface of the sheet.

These and other aspects, objects, features and advantages of the present invention, are specifically set forth in, or will become apparent from, the following detailed description of an exemplary embodiment of the invention when read in conjunction with the accompanying drawings.

### BRIEF DESCRIPTION OF THE DRAWINGS

FIG. 1 is an elevational view of a multi-layer sheet having a length and a width;

FIG. 2 is a schematic cross-sectional view illustrating a multi-layer laminate sheet, according to an embodiment of the present invention;

FIG. 3 is a schematic illustration of a laminate sheet self-wound into a roll form, according to another embodiment of the present invention;

FIG. 4 is a schematic cross-sectional view illustrating a multi-layer laminate sheet, according to yet another embodiment of the present invention;

FIG. 5 is a schematic cross-sectional view of a multi-layer laminate sheet, according to a further embodiment of the present invention; and

FIG. 6 is a flow chart illustrating a method according to a further embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention relates generally to laminate sheets for adhering to various surfaces. Although the following description may primarily discuss applying draped sheets for use as drop cloths, it is understood that the present invention may also be used for any application for applying a sheet to any surface. In one exemplary embodiment, the invention may comprise applying color and textured materials for decorating interior and exterior architectural surfaces (such as walls, floors, ceilings, and other appropriate surfaces).

The present invention may serve as a barrier device for preventing unwanted penetration of finishing materials from one surface onto another surface. The barrier device may be useful for protecting one surface from unwanted penetration of paint, varnish, or other substances while an adjacent surface is coated (such as a dropcloth). The barrier device may include a flexible sheet having a substantial width and a narrower first strip with removable adhesive on one side of the sheet and a second strip with removable adhesive on a second side of the sheet.

Ordinarily, wall insulation installation may include using polymeric sheets that are nailed in place to prevent moisture intrusion. Avoiding the intrusion of moisture, such as from airborne moisture, vapor, steam, rain, leakage, and the like, is crucial to prevent the development of mold, mildew, or other conditions resulting from unintended moisture entering building materials. Using the adhesive aspects of the present invention, one may find the present invention useful to serve as a vapor barrier or moisture barrier instead of nailing the sheet in place, to maintain the sheet flush and tight with the walls being insulated.

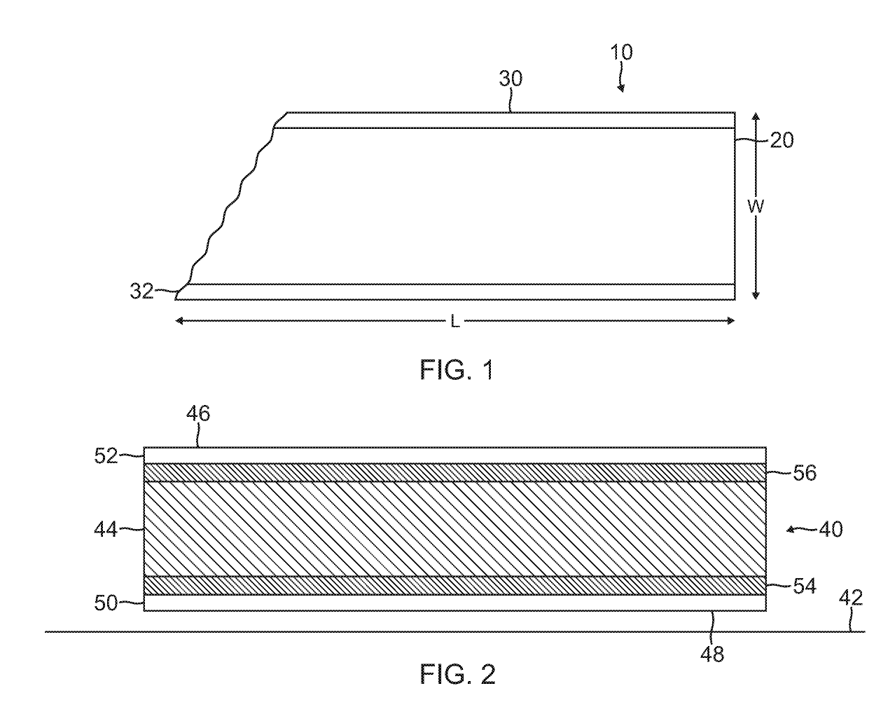

Referring now to the drawings in detail, wherein like reference characters refer to like elements, there is shown in FIG. 1 a sheet 10 where length L and width W of the sheet 10 is shown. The sheet 10 may comprise a polymer sheet material 20 that has a length and width. The length L and width W of the polymer sheet material 20 may be substantially coterminous with the length L and width W of removable strips 30, 32. Removable strip 30 may be considered to be a strip for the top of the sheet 10 while removable strip 32 may be considered to be a strip for the bottom of the sheet 10. If it becomes necessary to use more than one sheet 10 to cover an architectural surface, a second sheet may be combined with the first sheet 10 with ease, such as by removing the bottom removable strip 32 and pressing an edge of the underside of the second sheet onto the adhesive area under where the removed strip 32 was adhered previously.

FIG. 2 illustrates a multi-layer laminate sheet 40 adapted to be used as a surfacing film, drop cloth, or draping sheet. The multi-layer laminate sheet 40 may be used to be placed on a surface 42, such as a wall or other architectural surface. The sheet 40 may have polymer sheet material 44, an outside surface 46, and an inner surface 48. The sheet 40 may include a repositionable pressure-sensitive adhesive 54 situated on the underside of the sheet 40, an inside releasable liner 50 being releasably adhered to the underside of the sheet 40, an outside releasable liner 52 being releasably adhered to the outer side of the sheet 40 with adhesive layer 56. The inside releasable liner 50 is releasably adhered to the underside of the sheet 40.

Optionally, the present invention may be practiced with one or more releasable liners on one side of the sheet 40 but no releasable liners on an opposite side of the sheet 40.

Regarding the adhesive layers 54, 56, the adhesive may comprise a tackifier resin. The repositionable pressure-sensitive adhesive 54, 56 has a length and width. The adhesive may have a first tack after a first period of time for forming a repositionable bond, and a second tack after a second period of time, wherein the second period of time is longer than the first period of time, and the second tack is greater than the first tack for forming a substantially permanent bond. The adhesive may comprise one or more of: an acrylic polymer, a hydorcarbon polymer; or a urethane polymer. The adhesive may comprise one or more of: an acrylic polymer, a block co-polymer, a natural, reclaimed, or styrene-butadiene rubber, a tackified natural or synthetic rubber, a co-polymer of ethylene and divinyl acetate, an ethylene-vinyl-acrylicterpolymer, a polyisobutylene, or a polyvinyl ether.

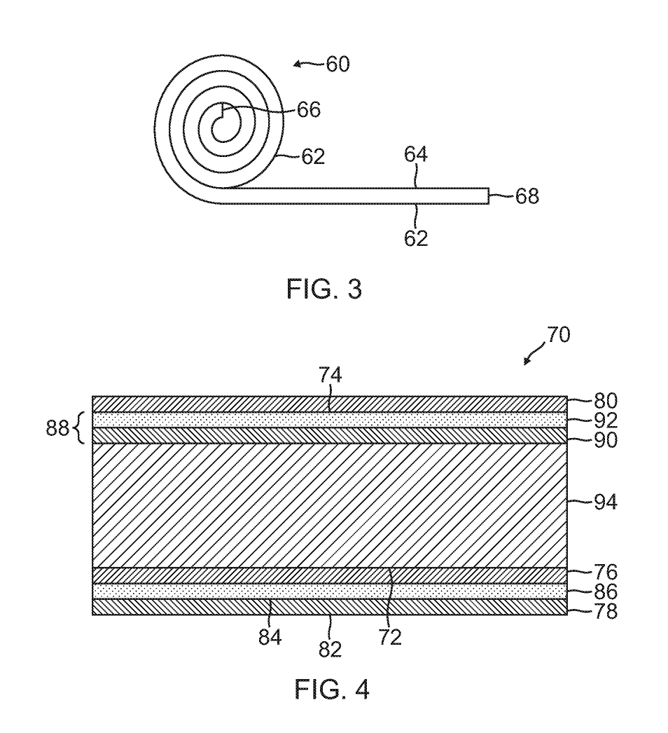

Referring to FIG. 3 the invention may be supplied in roll form with a plurality of turns in which the inside releasable liner side of the product is in contact with the adhesive side of the product. The sheet 60, with a first end 66 and a second end 68, may be self-wound into a roll form with an outer exposed surface 62 of an adhesive release coat layer in releasable contact with the exposed outer surface 64 of the adhesive layer, such that when the sheet 60 is unwound, the adhesive release coat layer on the release liner may separate from the outer surface of the adhesive layer and remain adhered to the release liner.

FIG. 4 shows a multi-layer laminate sheet 70 adapted to be used as a surfacing film or draping sheet. The multi-layer laminate sheet 70 may have an inside surface 72 and an outside surface 74. The sheet 70 may include a repositionable pressure-sensitive adhesive 76 situated on the inside surface 72 of the sheet 70, an inside releasable liner 78 being releasably adhered to the inside surface 72 of the sheet, an outside releasable liner 80 being releasably adhered to the outside surface 74 of the sheet 70, wherein the inside releasable liner 78 has an inner surface 84 and an outer surface 82, wherein the inner surface 84 of the inside releasable liner 78 is releasably adhered to the inside surface 72 of the sheet 70 and a release agent 86 is situated on the inner surface 84 of the inside releasable liner 78. The repositionable pressure-sensitive adhesive 76 has a length and width.

The sheet 70 may further comprise a dry color component 90 and a transparent or translucent topcoat 92 situated on the side of the dry color component adjacent the outside releasable liner. The topcoat 92 may comprise a three dimensional surface texture thereon. The dry color component 90 may comprise one or more color layers comprising a plurality of deposits of color marking material at least indirectly on a tinted layer, the tinted layer being at least partially visible through the color marking material. The sheet 70 may comprise a polymer sheet material 94, sandwiched between liners 78, 80.

Regarding the adhesive layer 76, the adhesive may comprise a tackifier resin. The adhesive may have a first tack after a first period of time for forming a repositionable bond, and a second tack after a second period of time, wherein the second period of time is longer than the first period of time, and the second tack is greater than the first tack for forming a substantially permanent bond. The adhesive may comprise one or more of: an acrylic polymer, a hydorcarbon polymer; or a urethane polymer. The adhesive may comprise one or more of: an acrylic polymer, a block co-polymer, a natural, reclaimed, or styrene-butadiene rubber, a tackified natural or synthetic rubber, a co-polymer of ethylene and divinyl acetate, an ethylene-vinyl-acrylicterpolymer, a polyisobutylene, or a polyvinyl ether.

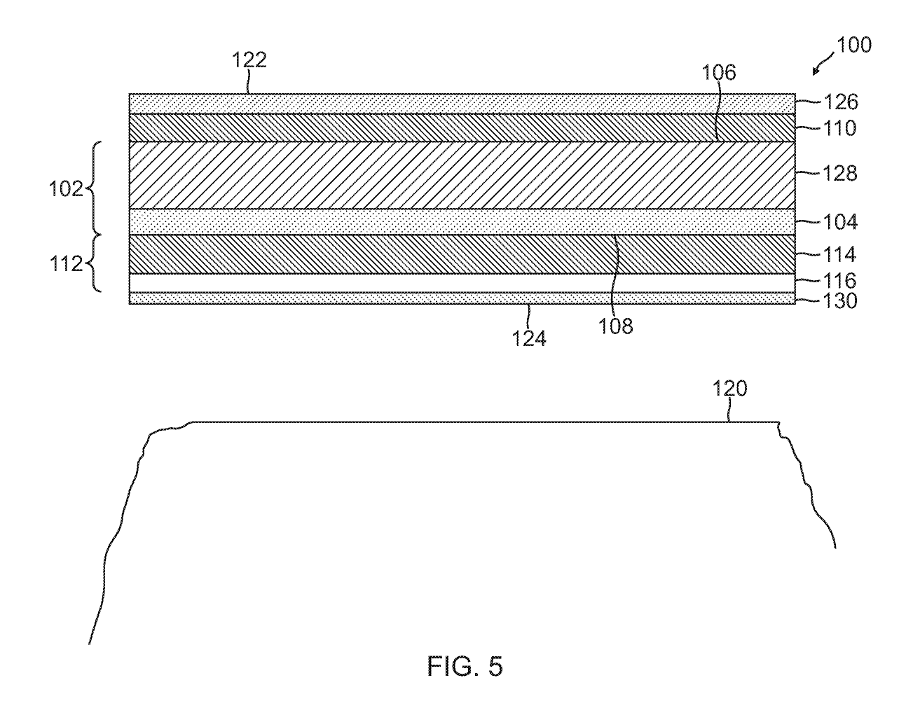

Referring now to FIG. 5, another embodiment of the present invention is shown. A self-wound multi-layer laminate sheet for applying a layer of color to a substrate surface 120 may use a laminate sheet 100 that comprises a dry paint layer 102 comprising a color layer 104 including a binder and a pigment, the dry paint layer having an upper surface 106 and a lower surface 108. A pressure-sensitive adhesive layer 110 may overlay the upper surface 106 of the dry paint layer 102 and adapted for adhering the laminate sheet 100 to a substrate surface 120. The laminate sheet 100 may comprise a polymer sheet material 128 situated between release liners 126, 130. The laminate sheet 100 may have an outside 122 surface and an inside surface 124.

A first release liner 112 may overlay the lower surface 108 of the dry paint layer 102, the first release liner 112 having a dry paint release coat 114 releasably adhered to the lower surface 108 of the dry paint layer 102, and an adhesive release coat layer 116 on a side of the first release liner 112 opposite from the dry paint release coat 114 removable from the dry paint layer 102. The sheet 100 may comprise a second release liner 126 on a side of the laminate sheet 100 opposite to the side of the laminate sheet 100 on which the first release liner 112 is located.

The dry paint release coat 114 may serve to transfer a controlled surface finish to an exposed surface of the dry paint layer 102 when the pressure-sensitive adhesive layer 110 adheres the laminate sheet 100 to the substrate surface 120 under the application of pressure and the release liners 126, 130 are peeled away from the dry paint layer 102.

The laminate sheet 100 may be adapted for being self-wound into a roll with the pressure-sensitive adhesive layer 110 in contact with the adhesive release coat layer 116, wherein the adhesive release coat layer 116 and the pressure-sensitive adhesive layer 110 may have an unwind release force between them which is lower than a carrier release force between the dry paint release and the dry paint layer 102, such that the adhesive release coat 116 preferentially releases the liner 126 from contact with the pressure-sensitive adhesive layer 110 when unwinding the laminate sheet 60 from its roll form (as shown in FIG. 3), while the dry paint release coat 114 maintains contact with the dry paint layer 102 when the laminate sheet 60 is being unwound from its roll form (as shown in FIG. 3). The invention may further comprise an embodiment wherein the pressure-sensitive adhesive in the pressure-sensitve adhesive layer is selected from the group consisting of a cross-linked acrylic resinous material, an internally cross-linked acrylic emulsion, and a cross-linked co-polymer emulsion of butyl acrylate and ethyl hexyl acrylate.

The dry paint release coat 114 may comprise a cross-linked resinous material bonded to the release liner 126, 130 and having a surface that transfers a controlled surface gloss to the dry paint layer 102.

In yet a further embodiment, the laminate sheet 100 may comprise an adhesive that is repositionable with a suppressed initial tack level that undergoes subsequent increase of adhesion due to the passage of time sufficient to permanently bond the dry paint layer to the substrate. The laminate sheet 100 may comprise a transparent outer clear coat layer comprising an acrylic resinous material. The laminate sheet 100 may additionally comprise a three dimensional surface texture thereon.

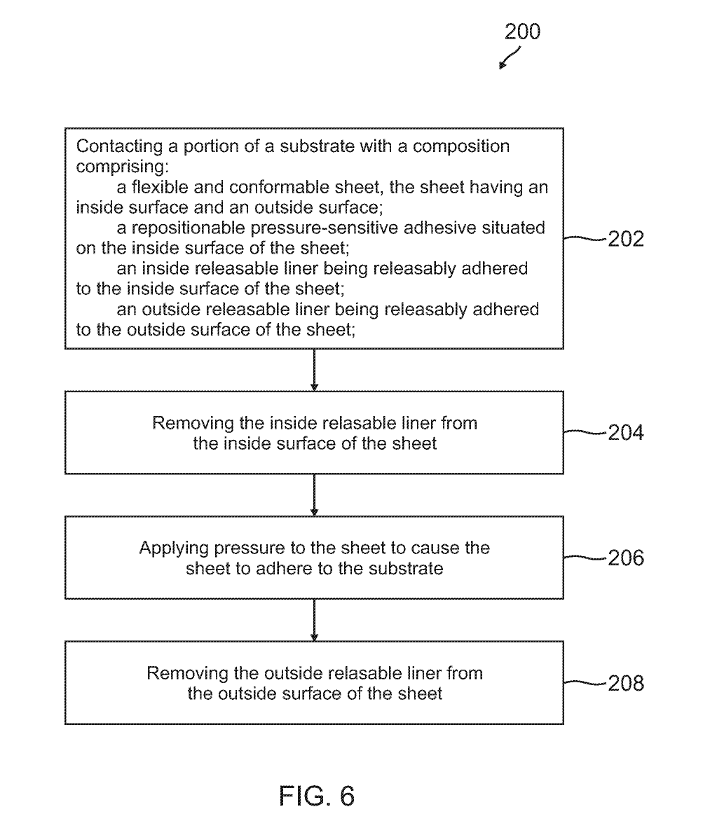

Turning now to FIG. 6, a flow chart illustrates a method 200 according to an embodiment of the present invention for applying a sheet on an architectural substrate. The method 200 may comprise a step 202 of contacting a portion of a substrate with a composition comprising; a flexible and conformable sheet, the sheet having an inside surface and an outside surface, a repositionable pressure-sensitive adhesive situated on the inside surface of the sheet, an inside releasable liner being releasably adhered to the inside surface of the sheet, an outside releasable liner being releasably adhered to the outside surface of the sheet. The method 200 may also comprise a step 204 of removing the inside releasable liner from the inside surface of the sheet and a step 206 of applying pressure to the sheet to cause the sheet to adhere to the substrate. Another step 208 may comprise removing the outside releasable liner from the outside surface of the sheet, for example, when applying another sheet to expand the coverage of the surface when one sheet is not sufficient to adequately cover the surface.

The method 200 may comprise using a substrate that comprises one or more of: a plastered wall, a painted wall, wallboard, particle board, wood, a wood-composite, concrete, or wallpaper. The sheet may comprise a three dimensional surface texture.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein.

I claim:

1. An architectural surface covering product, comprising:
a flexible and conformable sheet, the sheet having an inside surface and an outside surface;
a repositionable pressure-sensitive adhesive situated on the inside surface of the sheet;
an inside releasable liner being releasably adhered to the inside surface of the sheet;
an outside releasable liner being releasably adhered to the outside surface of the sheet;
wherein the inside releasable liner has an inner surface and an outer surface, wherein the inner surface of the inside releasable liner is releasably adhered to the inside surface of the sheet and a release agent is situated on the inner surface of the inside releasable liner.

2. The architectural surface covering product of claim 1, wherein the repositionable pressure-sensitive adhesive has a length and width;
the sheet comprises an opaque layer of dry paint in a continuous layer of color that has a length and width; and
the length and width of the continuous layer of color is substantially coterminous with the length and width of the repositionable pressure-sensitive adhesive.

3. The architectural surface covering product of claim 1, wherein the sheet further comprises a dry color component and a transparent or translucent topcoat situated on the side of the dry color component adjacent the outside releasable liner.

4. The architectural surface covering product of claim 3, wherein the topcoat comprises a three dimensional surface texture thereon.

5. The architectural surface covering product of claim 3, wherein the dry color component comprises one or more color layers comprising a plurality of deposits of color marking material at least indirectly on a tinted layer, the tinted layer being at least partially visible through the color marking material.

6. The architectural surface covering product of claim 1, wherein the adhesive has a first tack after a first period of time for forming a repositionable bond, and a second tack after a second period of time, wherein the second period of time is longer than the first period of time, and the second tack is greater than the first tack for forming a substantially permanent bond.

7. The architectural surface covering product of claim 1, wherein the architectural surface covering product is supplied in roll form with a plurality of turns in which the inside releasable liner side of the product is in contact with the adhesive side of the product.

8. The architectural surface covering product of claim 1, wherein the adhesive comprises one or more of: an acrylic polymer, a hydorcarbon polymer; or a urethane polymer.

9. The architectural surface covering product of claim 1, wherein the adhesive comprises one or more of: an acrylic polymer, a block co-polymer, a natural, reclaimed, or styrene-butadiene rubber, a tackified natural or synthetic rubber, a co-polymer of ethylene and divinyl acetate, an ethylene-vinyl-acrylicterpolymer, a polyisobutylene, or a polyvinyl ether.

10. The architectural surface covering product of claim 1, wherein the adhesive comprises a tackifier resin.

11. A self-wound multi-layer laminate sheet for applying a layer of color to a substrate surface, the laminate sheet comprising:
a dry paint layer comprising a color layer including a binder and a pigment, the dry paint layer having an upper surface and a lower surface;
a pressure-sensitive adhesive layer overlying the upper surface of the dry paint layer and adapted for adhering the laminate sheet to a substrate surface;
a first release liner overlying the lower surface of the dry paint layer, the release liner having a dry paint release coat releasably adhered to the lower surface of the dry paint layer, and an adhesive release coat layer on a side of the release liner opposite from the dry paint release coat removable from the dry paint layer; and
a second release liner on a side of the laminate sheet opposite to the side of the laminate sheet on which the first release liner is located;
wherein the dry paint release coat transferring a controlled surface finish to an exposed surface of the dry paint layer when the pressure-sensitive adhesive layer adheres the laminate sheet to the substrate surface under the application of pressure and the release liner is peeled away from the dry paint layer;
wherein the laminate sheet is adapted for being self-wound into a roll with the pressure-sensitive adhesive layer in contact with the adhesive release coat layer;
wherein the adhesive release coat layer and the pressure-sensitive adhesive layer have an unwind release force between them which is lower than a carrier release force between the dry paint release and the dry paint layer, such that the adhesive release coat preferentially releases the liner from contact with the pressure-sensitive adhesive layer when unwinding the laminate sheet from its roll form, while the dry paint release coat maintains contact with the dry paint layer when the laminate is being unwound from its roll form;
wherein the pressure-sensitive adhesive is selected from the group consisting of a cross-linked acrylic resinous material, an internally cross-linked acrylic emulsion, and a cross-linked co-polymer emulsion of butyl acrylate and ethyl hexyl acrylate.

12. The laminate sheet of claim 9, wherein the dry paint release coat comprises a cross-linked resinous material bonded to the release liner and having a surface that transfers a controlled surface gloss to the dry paint layer.

13. The laminate sheet of claim 9, wherein the adhesive is repositionable with a suppressed initial tack level that undergoes subsequent increase of adhesion due to the passage of time sufficient to permanently bond the dry paint layer to the substrate.

14. The laminate sheet of claim 9, further comprising a transparent outer clear coat layer comprising an acrylic resinous material.

15. The laminate sheet of claim 9, further comprising a three dimensional surface texture thereon.

16. A method of applying a sheet on an architectural substrate, comprising:
contacting a portion of a substrate with a composition comprising:
a flexible and conformable sheet, the sheet having an inside surface and an outside surface;
a repositionable pressure-sensitive adhesive situated on the inside surface of the sheet;
an inside releasable liner being releasably adhered to the inside surface of the sheet;
an outside releasable liner being releasably adhered to the outside surface of the sheet;
removing the inside releasable liner from the inside surface of the sheet;
applying pressure to the sheet to cause the sheet to adhere to the substrate; and
removing the outside releasable liner from the outside surface of the sheet.

17. The method of claim 16, wherein the substrate comprises one or more of: a plastered wall, a painted wall, wallboard, particle board, wood, a wood-composite, concrete, or wallpaper.

18. The method of claim 16, wherein the sheet comprises a three dimensional surface texture.
